(19) United States
(12) Patent Application Publication
(10) Pub. No.: US 2009/0291291 A1
(43) Pub. Date: Nov. 26, 2009

(54) FLAME RETARDANT PRESSURE SENSITIVE ADHESIVE

(75) Inventor: Thomas C. Epple, Madison, OH (US)

Correspondence Address: Avery Dennison Corporation;Amanda Wittine, 8080 Norton Parkway, 22-D, Mentor, OH, 44060, US

(73) Assignee: AVERY DENNISON CORPORATION, Pasadena, CA (US)

(21) Appl. No.: 12/306,375

(22) PCT Filed: Mar. 29, 2007
(86) PCT No.: PCT/US07/65426

§ 371 Date: Feb. 5, 2009

Related U.S. Application Data
(60) Provisional application No. 60/805,654, filed on Jun. 23, 2006.

(51) Int. Cl. C09J 9/00; B32B 15/04; B32B 3/26; C09J 7/02; C09J 11/02; C08K 5/52

(52) U.S. Cl. 428/317.3; 428/356; 428/344; 106/287.23; 106/287.18; 524/151

(57) ABSTRACT

A flame retardant adhesive pressure sensitive adhesive containing a blend of flame retardants is provided. The flame retardant blend comprises (a) at least one metal oxide; (b) at least one metal hydrate; (c) at least one halogenated material; and (d) a liquid phosphorous-bromine containing composition comprising a triaryl phosphate ester having low triphenyl phosphate content.

This application claims the benefit of U.S. Provisional Application No. 60/805,654 filed Jun. 23, 2006, the contents of which are hereby incorporated by reference in their entirety.

### TECHNICAL FIELD

The present invention relates to a flame retardant pressure sensitive adhesive composition having superior tackiness and flame retardancy and a flame retardant pressure sensitive adhesive tape using the composition.

### BACKGROUND

Many applications exist for pressure sensitive adhesives (PSA) and pressure sensitive adhesive tapes that are flame retardant. In the construction industry, there are often strict regulations relating to the flame retardancy of the construction materials used, and in particular, to the materials used in public buildings. In other industries such as the automotive, aerospace and electrical industries, flame retardant PSAs and PSA tapes are of considerable importance.

In the aerospace industry, the Federal Aviation Administration (FAA) has prescribed stringent requirements for materials used in the construction of the interior compartments occupied by the airline crew and passengers, including interior ceiling panels, interior wall panels, partitions, galley structures, cabinet walls, structural flooring and materials used in the construction of stowage compartments. F.A.R. §25.856(a) (July 2003) is the testing criteria for the FAA's Radiant Panel Burn Test, which relates to the materials used for carpet tapes, seat cushions, padding, decorative and non-decorative coated fabrics, leather, trays and galley furnishings, electrical conduit, thermal and acoustical insulation and insulation covering air ducting, joint and edge covering and the like.

A need exists for flame retardant pressure sensitive adhesives that satisfy the requirements of the more stringent testing criteria of F.A.R. §25.856(a).

### SUMMARY

In one embodiment of the invention, there is provided a flame retardant pressure sensitive adhesive composition comprising a base pressure sensitive adhesive material and a flame retardant component. The flame retardant component comprises a blend of (a) at least one metal oxide; (b) at least one metal hydrate; (c) at least one halogenated material; and (d) a liquid phosphorous-bromine containing composition comprising a triaryl phosphate ester having low triphenyl phosphate content. The adhesive composition, in one embodiment, is free of polybrominated diphenyl compounds.

### DETAILED DESCRIPTION

The invention provides an adhesive composition comprising a base pressure sensitive adhesive material; and a flame retardant component comprising a blend of (a) at least one metal oxide; (b) at least one metal hydrate; (c) at least one halogenated material; and (d) a liquid phosphorous-bromine containing composition comprising a triaryl phosphate ester having low triphenyl phosphate content.

As used herein, the term “flame retardant” refers to a substance that when applied to or incorporated into a combustible material, reduces or eliminates its tendency to ignite when exposed to heat or a low-energy flame.

The flame retardant adhesive of the invention is formulated to pass F.A.R. §25.856(a) Radiant Panel Burn Test (July 2003) when used in adhesive tape and adhesive article constructions.

The base adhesive may be selected from any of a variety of materials, such as acrylics, polyurethanes, thermoplastic elastomers, block copolymers, polyolefins, silicones, rubber based adhesives and blends of two or more of the foregoing.

The blend of flame retardants comprises at least one metal oxide. Useful metal oxides include, for example, aluminum oxide, titanium dioxide, antimony oxide, antimony trioxide, antimony pentoxide, zinc oxide, zinc borate, and ferric oxide. The blend also comprises at least one metal hydrate. Useful metal hydrates include, for example, alumina trihydrate, magnesium hydroxide, calcium hydroxide, and magnesium carbonate.

The halogenated flame retardant of the blend may be chosen from hexabromocyclododecane, decachlorodipenyl ether, bis(tribromophenoxy) ethane, bis(tribromophenyl)ether, poly(dibromophenylene oxide), hexabromobenzene, pentabromoethyl benzene, ethylene-bis (tetrabromophthalimide), perchloropentacyclodecane, pentabromotoluene, pentabromochloro-cyclohexane, ethylene bis tris(2-cyanoethyl) phosphonium bromide, halogenated phosphate esters such as tri(betachloroethyl) phosphate, tris(chloropropyl) phospate, tris (dichloropropyl)phosphate, chlorinated polyphosphate, tris(2,3-dibromopropyl) phosphate, and mixtures of two or more of the foregoing halogenated flame retardants. A particularly useful halogenated flame retardant is hexabromocyclodecane. In one embodiment, the adhesive composition contains no polybrominated diphenyls, such as, pentabromodiphenylether, octobromodiphenylether and decabromodiphenyl ether.

The blend of flame retardants in the adhesive composition also includes a liquid phosphorus-bromine flame retardant. This flame retardant comprises an isopropylate triaryl phosphate having low triphenyl phosphate and a bromine source. The bromine content of the flame retardant is about 27.1% by weight. The viscosity of the liquid flame retardant is about 177 cps at 20° C. The liquid flame retardant is commercially available from Great Lakes Chemical Company under the trade name FIREMASTER® 550.

In one embodiment, the flame retardant blend comprises (a) about 10% to about 20% by weight of at least one metal oxide; (b) about 10% to about 30% by weight of at least one metal hydrate; (c) about 45% to about 70% by weight of at least one halogenated material; and (d) about 5% to about 20% by weight of a liquid phosphorous-bromine containing composition comprising a triaryl phosphate ester having low triphenyl phosphate content.

In one embodiment, the flame retardant blend comprises (a) about 12% to about 17% by weight of at least one metal oxide; (b) about 15% to about 25% by weight of at least one metal hydrate; (c) about 50% to about 65% by weight of at least one halogenated material; and (d) about 7% to about 15% by weight of a liquid phosphorous-bromine containing composition comprising a triaryl phosphate ester having low triphenyl phosphate content.

### Base Adhesive

The base pressure sensitive adhesive material of the composition can be selected from a wide variety of materials. A description of useful pressure sensitive adhesive may be found in Encyclopedia of Polymer Science and Engineering, Vol. 13, Wiley-Interscience Publishers (New York, 1988). Additional description of useful PSAs may be found in Encyclopedia of Polymer Science and Technology, Vol. 1, Interscience Publishers (New York, 1964).

The base PSA can be acrylic based such as those taught in U.S. Pat. No. 5,164,444 (acrylic emulsion), U.S. Pat. No. 5,623,011 (tackified acrylic emulsion) and U.S. Pat. No. 6,306,982. The adhesive can also be rubber-based such as those taught in U.S. Pat. No. 5,705,551 (rubber hot melt). It can also be radiation curable mixture of monomers with initiators and other ingredients such as those taught in U.S. Pat. No. 5,232,958 (UV cured acrylic) and U.S. Pat. No. 5,232,958 (EB cured). The disclosures of these patents and the pending application as they relate to acrylic adhesives are hereby incorporated by reference.

Commercially available PSAs are useful in the invention. Examples of these adhesives include the hot melt PSAs available from H. B. Fuller Company, St. Paul, Minn. as HM-1597, HL-2207-X, HL-2115-X, HL-2193-X. Other useful commercially available PSAs include those available from Century Adhesives Corporation, Columbus, Ohio. Another useful acrylic PSA comprises a blend of emulsion polymer particles with dispersion tackifier particles as generally described in Example 2 of U.S. Pat. No. 6,306,982. The polymer is made by emulsion polymerization of 2-ethylhexyl acrylate, vinyl acetate, dioctyl maleate, acrylic and methacrylic comonomers as described in U.S. Pat. No. 5,164,444 resulting in the latex particle size of about 0.2 microns in weight average diameters and a gel content of about 60%.

Conventional PSAs, including silicone-based PSAs, rubber-based PSAs, and acrylic-based PSAs are useful. A commercial example of a hot melt adhesive is H2187-01, sold by Ato Findley, Inc., of Wauwatusa, Wis. In addition, rubber based block copolymer PSAs described in U.S. Pat. No. 3,239,478 also can be utilized in the adhesive constructions of the present invention, and this patent is hereby incorporated by a reference for its disclosure of such hot melt adhesives that are described more fully below.

In one embodiment, the base adhesive may be formed from an acrylic based polymer. It is contemplated that any acrylic based polymer capable of forming an adhesive layer with sufficient tack to adhere to a substrate may function in the present invention. In certain embodiments, the acrylic polymers for the pressure-sensitive adhesive layers include those formed from polymerization of at least one alkyl acrylate monomer containing from about 4 to about 12 carbon atoms in the alkyl group, and present in an amount from about 35-95% by weight of the polymer or copolymer, as disclosed in U.S. Pat. No. 5,264,532. Optionally, the acrylic based pressure-sensitive adhesive might be formed from a single polymeric species.

Advantageously, the glass transition temperature of a PSA layer comprising acrylic polymers can be varied by adjusting the amount of polar, or “hard monomers”, in the copolymer, as taught by U.S. Pat. No. 5,264,532, incorporated herein by reference. The greater the percentage by weight of hard monomers is an acrylic copolymer, the higher the glass transition temperature. Hard monomers contemplated useful for the present invention include vinyl esters, carboxylic acids, and methacrylates, in concentrations by weight ranging from about zero to about thirty-five percent by weight of the polymer.

In another embodiment, the pressure-sensitive adhesive utilized in the present invention comprise rubber based elastomer materials containing useful rubber based elastomer materials include linear, branched, grafted, or radial block copolymers represented by the diblock structure A-B, the triblock A-B-A, the radial or coupled structures (A-B)ₙ, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. The preferred rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Particularly preferred rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be utilized include any of those which exhibit elastomeric properties. The block copolymers may be diblock, triblock, multiblock, starblock, polyblock or graftblock copolymers. Throughout this specification, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0, 1, 2} . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes that may be utilized to prepare the polymers and copolymers are those containing from 4 to about 10 carbon atoms and more generally, from 4 to 6 carbon atoms. Examples include from 1,3-butadiene, 2-methyl-1,3-butadiene(isoprene), 2,3-dimethyl-1,3-butadiene, chloroprene, 1,3-pentadiene, 1,3-hexadiene, etc. Mixtures of these conjugated dienes also may be used. The preferred conjugated dienes are isoprene and 1,3-butadiene.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc. The preferred vinyl aromatic hydrocarbon is styrene.

Many of the above-described copolymers of conjugated dienes and vinyl aromatic compounds are commercially available. The number average molecular weight of the block copolymers, prior to hydrogenation, is from about 20,000 to about 500,000, preferably from about 40,000 to about 300,000.

The average molecular weights of the individual blocks within the copolymers may vary within certain limits. In most instances, the vinyl aromatic block will have a number average molecular weight in the order of about 2000 to about 125,000, and preferably between about 4000 and 60,000. The conjugated diene blocks either before or after hydrogenation will have number average molecular weights in the order of about 10,000 to about 450,000 and more preferably from about 35,000 to 150,000.

Also, prior to hydrogenation, the vinyl content of the conjugated diene portion generally is from about 10% to about 80%, and the vinyl content is preferably from about 25% to about 65%, particularly 35% to 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present invention include those available from Kraton Polymers LLC under the KRATON trade name.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene-isoprene-styrene such as a styrene-(ethylene/propylene)styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed as isoprene, the resulting hydrogenated product resembles a regular copolymer block of ethylene and propylene (EP).

A number of selectively hydrogenated block copolymers are available commercially from Kraton Polymers under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available under the designation Kraton G1650. Kraton G1651 is another SEBS block copolymer which contains about 33% by weight of styrene. Kraton G1657 is an SEBS diblock copolymer which contains about 13% w styrene. This styrene content is lower than the styrene content in Kraton G1650 and Kraton G1652.

In another embodiment, the selectively hydrogenated block copolymer is of the formula

Bₙ(AB)ₒAₚ

wherein n=0 or 1; o is 1 to 100; p is 0 or 1; each B prior to hydrogenation is predominantly a polymerized conjugated diene hydrocarbon block having a number average molecular weight of about 20,000 to about 450,000; each A is predominantly a polymerized vinyl aromatic hydrocarbon block having a number average molecular weight of from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction between the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy) hexane by a melt reaction in a twin screw extruder.

Examples of commercially available maleated selectively hydrogenated copolymers of styrene and butadiene include Kraton FG1901X, FG1921X, and FG1924X, often referred to as maleated selectively hydrogenated SEBS copolymers. FG1901X contains about 1.7% w bound functionality as succinic anhydride and about 28% w of styrene. FG1921X contains about 1% w of bound functionality as succinic anhydride and 29% w of styrene. FG1924X contains about 13% styrene and about 1% bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

Unsaturated elastomeric polymers and other polymers and copolymers which are not inherently tacky can be rendered tacky when compounded with an external tackifier. Tackifiers, are generally hydrocarbon resins, wood resins, rosins, rosin derivatives, and the like, which when present in concentrations ranging from about 40% to about 90% by weight of the total adhesive composition, more preferably from about 45% to about 85% by weight, impart pressure-sensitive adhesive characteristics to the elastomeric polymer adhesive formulation. Compositions containing less than about 40% by weight of tackifier additive do not generally show sufficient “quickstick,” or initial adhesion, to function as a pressure-sensitive adhesive, and therefore are not inherently tacky. Compositions with too high a concentration of tackifying additive, on the other hand, generally show too little cohesive strength to work properly in most intended use applications of constructions made in accordance with the instant invention.

It is contemplated that any tackifier known by those of skill in the art to be compatible with elastomeric polymer compositions may be used with the present embodiment of the invention. One such tackifier, found useful is Wingtak 10, a synthetic polyterpene resin that is liquid at room temperature, and sold by the Goodyear Tire and Rubber Company of Akron, Ohio. Wingtak 95 is a synthetic tackifier resin also available from Goodyear that comprises predominantly a polymer derived from piperylene and isoprene. Other suitable tackifying additives may include Escorez 1310, an aliphatic hydrocarbon resin, and Escorez 2596, a C₅-C₈ (aromatic modified aliphatic) resin, both manufactured by Exxon of Irving, Tex. Of course, as can be appreciated by those of skill in the art, a variety of different tackifying additives may be used to practice the present invention.

In addition to the tackifiers, other additives may be included in the PSAs to impart desired properties. For example, plasticizers may be included, and they are known to decrease the glass transition temperature of an adhesive composition containing elastomeric polymers. An example of a useful plasticizer is Shellflex 371, a naphthenic processing oil available from Shell Lubricants of Texas. Antioxidants also may be included on the adhesive compositions. Suitable antioxidants include Irgafos 168 and Irganox 565 available from Ciba-Geigy, Hawthorne, N.Y. Cutting agents such as waxes and surfactants also may be included in the adhesives.

The flame retardant adhesives of the present invention may be coated onto a substrate to produce a PSA tape. The substrate may be a polymeric film, a woven or non-woven substrate, a metallic film, a foam, or composites of multiple layers of one or more thereof. The adhesive may be coated directly onto the substrate, or transferred to the substrate in a transfer process. For coating in a transfer process, the PSA film is first deposited onto an in-line process liner or a siliconized or fluorinated release liner and then laminated to the substrate.

### EXAMPLES

The following examples are intended only to illustrate methods and embodiments in accordance with the invention, and as such should not be construed as imposing limitations upon the claims.

### Testing Methods:

### Peel Adhesion:

Peel adhesion is the average force to remove an adhesive laminated under specified conditions on a substrate, from the substrate at constant speed and at a specified angle, usually 90° or 180°. The indicated adhesive constructions are prepared as described below. The substrates used are indicated in Table 2. The resulting construction is die-cut into strips each having an approximate size of 25×204 mm (1×8 in). The strips are centered along the lengthwise direction and applied to 50×152 mm (2×6 in) brightly annealed, highly polished stainless steel test panels that had been washed with diacetone alcohol. The strips are rolled down using a 2 kg (4.5 lb), 5.45 pli 65 shore “A” rubber-faced roller, rolling back and forth once, at a rate of 30 cm/min (12 in/min). The samples are conditioned for 20 minutes in a controlled environment testing room maintained at 21° C. (70° F.) and 50% relative humidity. After conditioning, the test strips are peeled away from the test panel in an Instron Universal Tester according to a modified version of the standard tape method Pressure-Sensitive Tape Council, PSTC-2 (rev. 1995), Peel Adhesion for Single Coated Tapes, where the peel angle is 90°, at a rate of 50 cm/min (20 in/min). A peel angle of 180° is also used. A load cell linked to a computer is used to estimate the reported values. The force to remove the adhesive test strip from the test panel is measured in pounds per inch of width (lb/in-w). All tests are conducted in triplicate. The results are shown in Table 2 below.

### Loop Tack:

Loop tack measurements are made for strips that are about 25 mm (1 inch) wide using stainless steel as the substrate at a draw rate of about 50 cm/min (20 in/min), according to standard test 1994 Tag and Label Manufacturers Institute, Inc. (TLMI) Loop Tack Test L-1B2, using an Instron Universal Testor Model 4501 from Instron (Canton, Mass.). Loop tack values are taken to be the highest measured adhesion value observed during the test. The results, reported in lb/in-w, are set out in Table 2, where the substrate is stainless steel Stellite.

### Shear Adhesion Failure Temperature (SAFT):

The shear adhesion failure test is a modification of ASTM D-4498—a standard test method for the heat-fail temperature in shear of hot melt adhesives. As described in this method, the samples are assembled as in the shear test using a 1000-gram load and placed into a test chamber. The temperature of the chamber starts at ambient and after a dwell time of 20 minutes at 100° F., is ramped upward at a prescribed rate (40° F. per hour). The temperature at which the adhesive layer fails is noted is the shear adhesion failure temperature (SAFT).

In the following examples, the abbreviations used have the following meanings:

ABS: acrylonitrile butadiene styrene

SS: stainless steel

PET: polyethylene terephthalate

PU: polyurethane

PE: polyethylene

RT: room temperature

### Example 1

A flame retardant blend is prepared from the following components:

TABLE 1

| Component | Amount (Wt. %) |
|---|---|
| Antimony trioxide | 14.5 |
| Hexabromocyclododecane | 58.1 |
| Alumina trihydrate | 17.7 |
| Firemaster 550 | 9.6 |

### Example 2

A flame retardant adhesive composition is formulated by combining the flame retardant blend of Example 1 with an acrylic adhesive Aroset 1085 from Ashland Chemicals that has been compounded with tackifiers and other additives. The flame retardant adhesive comprises 62% by weight of the flame retardant blend and 38% by weight of the acrylic adhesive. For testing, the adhesive is coated onto a 2 mil PET film at a thickness of either 2 mils or 4 mils.

### Example 3

A flame retardant adhesive composition is formulated by combining the flame retardant blend of Example 1 with an acrylic adhesive AS-801XL from Avery Dennison Performance Polymers. The flame retardant adhesive comprises 62% by weight of the flame retardant blend and 38% by weight of the acrylic adhesive. For testing, the adhesive is coated onto a 2 mil PET film at a thickness of either 2 mils or 4 mils.

TABLE 2

| Peel Adhesion | | | Ex 2 | Ex 2 | Ex 3 | Ex 3 |
|---|---|---|---|---|---|---|
| 180° (lb/in-w) | Substrate | Dwell | 2 mils | 4 mils | 2 mils | 4 mils |
| | ABS | 10 min.@RT | 2.0 | 3.9 | 1.8 | 3.4 |
| | SS | 10 min.@RT | 2.4 | 4.6 | 2.3 | 4.0 |
| | Aluminum | 10 min.@RT | 2.1 | 4.9 | 2.7 | 4.1 |
| | ABS | 72 min.@RT | 2.7 | 4.8 | 3.2 | 4.8 |
| | SS | 72 min.@RT | 2.9 | 6.1 | 3.6 | 5.4 |
| | Aluminum | 72 min.@RT | 3.3 | 8.6 | 4.5 | 7.0 |
| Loop Tack | | | 1.5 | 3.1 | 1.0 | 2.1 |
| (lb/in-w) | | | | | | |
| Foam Peel | PET | | 0.7 | 1.3 | 0.3 | 1.0 |
| 90° | | | | | | |
| (lb/in-w) | | | | | | |
| | PU | | 1.2 | 3.8 | 0.3 | 5.8 |
| | PE | | 3.1 | 3.2 | 0.9 | 2.4 |
| | Melamine | | 1.1 | 3.0 | 0.3 | 0.7 |
| Aged Foam | Melamine | 1 Week @ 70° C. | 2.48 | 4.72 | 1.61 | 6.55 |
| Peel 90° (lb/in-w) | | | | | | |
| | Melamine | 2 Weeks @ | 0.76 | 1.63 | 1.41 | 4.93 |
| | | 70° C. | | | | |
| SAFT | | | 91° F. | 94° F. | 116° F. | 119° F. |

While the invention has been explained in relation to embodiments, it is to be understood that various modifications thereof will become apparent to those skilled in the art upon reading the specification. Therefore, it is to be understood that the inventions disclosed herein is intended to cover such modifications as fall within the scope of the appended claims, and to cover insubstantial variations thereof.

1. A flame retardant pressure sensitive adhesive composition comprising
a base pressure sensitive adhesive material; and
a flame retardant component comprising a blend of (a) at least one metal oxide; (b) at least one metal hydrate; (c) at least one halogenated flame retardant; and (d) a liquid phosphorous-bromine containing composition comprising a triaryl phosphate ester having low triphenyl phosphate content wherein (d) is different from (c).

2. The flame retardant adhesive composition of claim 1 wherein the metal oxide comprises antimony oxide, magnesium oxide or aluminum oxide, or combinations of two or more thereof.

3. The flame retardant adhesive composition of claim 1 wherein the metal hydrate comprises aluminum trihydrate.

4. The flame retardant adhesive composition of claim 1 wherein the halogenated flame retardant comprises hexabromocyclododecane.

5. The flame retardant adhesive composition of claim 1 wherein the base pressure sensitive adhesive comprises an acrylic adhesive.

6. The flame retardant adhesive composition of claim 1 wherein the base pressure sensitive adhesive comprises a rubber-based adhesive.

7. The flame retardant adhesive composition of claim 1 wherein the base pressure sensitive adhesive comprises a silicone-based adhesive.

8. The flame retardant adhesive composition of claim 1 wherein the flame retardant component comprises (a) about 10% by weight to about 20% by weight of antimony trioxide; (b) about 12% by weight to about 25% by weight of aluminum trihydrate; (c) about 45% by weight to about 65% by weight of hexabromocyclododecane; and (d) about 5% by weight to about 15% by weight of a liquid phosphorous-bromine containing composition comprising a triaryl phosphate ester having low triphenyl phosphate content.

9. The flame retardant adhesive composition of claim 1 comprising about 25% to about 50% by weight of the base pressure sensitive adhesive material and about 50% to about 75% by weight of the flame retardant component.

10. The flame retardant adhesive composition of claim 1 wherein the flame retardant component is free of polybrominated diphenyl compounds.

11. An adhesive article comprising
a substrate; and
a flame retardant pressure sensitive adhesive composition comprising (i) a base pressure sensitive adhesive material; and (ii) a flame retardant component comprising a blend of
(a) at least one metal oxide;
(b) at least one metal hydrate;
(c) hexabromocyclododecane; and
(d) a liquid phosphorous-bromine containing composition comprising a triaryl phosphate ester having low triphenyl phosphate content.

12. The adhesive article of claim 11 wherein the article is capable of meeting the standards of the F.A.R. §25.856 radiant panel burn test.

13. The adhesive article of claim 11 wherein the substrate comprises a polymeric film.

14. The adhesive article of claim 11 wherein the substrate comprises a metal foil.

15. The adhesive article of claim 11 wherein the substrate comprises a foam.

16. The adhesive article of claim 11 wherein the adhesive has a 180° peel strength of a least 4 lb/in on a stainless steel substrate.
